(19) United States
(12) Patent Application Publication
(10) Pub. No.: US 2018/0084607 A1
(43) Pub. Date: Mar. 22, 2018

(54) SELF REGULATING MECHANISM FOR STORAGE WATER HEATER

(71) Applicant: William Atchison, East Nassau, NY (US)

(72) Inventor: William Atchison, East Nassau, NY (US)

(21) Appl. No.: 15/272,309

(22) Filed: Sep. 21, 2016

(51) Int. Cl. H05B 1/02; H01H 35/18

(52) U.S. Cl. CPC H05B 1/0244; H05B 2203/021; H01H 35/18

(57) ABSTRACT

A self regulating mechanism for a storage water heater for preventing the operation of heating elements while the heating elements are not submerged comprises a liquid level switch and an electrical contactor which are each integrated with a storage water heater having at least a water tank, at least one heating element and thermostat pair, and an input voltage line. In operation, the electrical contactor is wired to selectively control the flow of electricity from the input voltage line to the thermostats and heating elements and the liquid level switch is operative to determine the water level and operate the switching of the electrical contactor based on whether the level of water in the water tank meets a predetermined threshold. As such, the electrical contactor will only permit electricity to flow to the heating element when the liquid level switch indicates that the water tank is substantially full.

### BACKGROUND OF THE INVENTION

### Field of the Invention

This invention relates generally to heating devices and, more particularly, to a self regulating mechanism for a storage water heater which automatically controls heating coil operation based on the water level in the water storage tank.

### Description of the Prior Art

The use and design of convention storage water heaters to provide the instantaneous delivery of hot water is well established. Such conventional storage water heaters generally operate by using a heating means driven by a fuel, such as electricity or propane, to heat water stored in a tank which then can be availed as desired through conventional plumbing or other means. A problem which still exists, however, is that for storage water heaters which employ a electrically driven heating means, such a heating means is subject to significant damage if operated without sufficient water in the tank. Furthermore, when installing or testing such a water heater, it is often difficult to ascertain the water level in the tank in order to know whether the heating means can be activated. Thus, there remains a need for a regulating mechanism for a storage water heater which automatically restricts the operation of heating element when the heating elements are not submerged in water. It would be helpful if such a self regulating mechanism for a storage water heater was integrated into the top of the storage water heater for ease of access. It would be additionally desirable for such a self regulating mechanism for a storage water heater to employ a liquid level switch which automatically interrupted the flow of electricity to the heating elements when the water in the tank fell below a preset threshold.

The Applicant's invention described herein provides for a regulating mechanism for a storage water heater adapted to control the flow of electricity to the heating elements of a storage water heater. The primary components in Applicant's self regulating mechanism are a liquid level switch and a contactor. When in operation, self regulating mechanism for a storage water heater effectively prevents the heating elements of a storage water heater from burning out. As a result, many of the limitations imposed by prior art structures are removed.

### SUMMARY OF THE INVENTION

A self regulating mechanism for a storage water heater for preventing the operation of heating elements while the heating elements are not submerged. The self regulating mechanism comprises a liquid level switch and an electrical contactor which are each integrated with a storage water heater having at least a water tank, at least one heating element and thermostat pair, and an input voltage line. In operation, the electrical contactor is wired to selectively control the flow of electricity from the input voltage line to the thermostats and heating elements and the liquid level switch is operative to detect the level of water in the water tank and operate the switching of the electrical contactor based on whether the level of water in the water tank surpasses a threshold defined by the uppermost heating element in the water tank. In this regard, the electrical contactor will only permit electricity to flow to the heating element when the liquid level switch indicates that the water tank is substantially full.

It is an object of this invention to provide a need for a regulating mechanism for a storage water heater which automatically restricts the operation of heating element when the heating elements are not submerged in water.

It is another object of this invention to provide a self regulating mechanism for a storage water heater integrated into the top of the storage water heater for ease of access.

It is yet another object of this invention to provide a self regulating mechanism for a storage water heater that employs a liquid level switch which automatically interrupted the flow of electricity to the heating elements when the water in the tank fell below a preset threshold.

These and other objects will be apparent to one of skill in the art.

### BRIEF DESCRIPTION OF THE DRAWINGS

FIG. 1 is a front perspective view of a storage water heater with a self regulating mechanism built in accordance with the present invention in an energizing position.

### DETAILED DESCRIPTION OF THE INVENTION

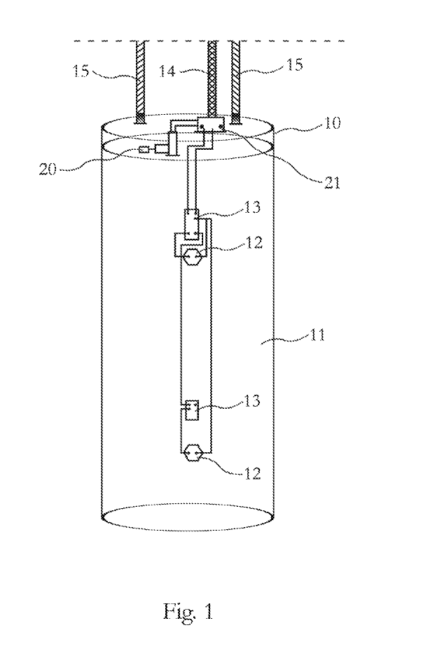

Referring now to the drawings and in particular FIG. 1, a self regulating mechanism for a storage water heater 10 is shown as a liquid level switch 20 attached to the top of the inner water tank 11 of the storage water heater 10 and an electrical contactor 21 positioned on top of the storage water heater 10 housing. As with conventional electric water heaters, the storage water heater 10 includes the water tank 11, a plurality of heating elements 12, commonly defined as electrical coils, a thermostat 13 associated with each heating element, an input voltage line 14 which delivers electrical power from a source (generally a main electricity source), and hot and cold water lines 15.

In accordance with the self regulating mechanism of the instant disclosure, the electrical contactor 21 is wired to selectively control the flow of electricity from the input voltage line 14 to the thermostats 13 and heating elements 12. In this regard, by the operation of the electrical contactor 21, a circuit can be selectively made to allow electricity from the input voltage line 14 to the thermostats 13 and heating elements 12 and broken to interrupt to flow of electricity from the input voltage line 14 to the thermostats 13 and heating elements 12.

In one embodiment, a pair of indicator lights are disposed on the storage water heater 10. Such indicator lights, which may be positioned on the exterior of the housing of the electrical contactor 21, provide a visual indication of whether power is going to the contactor, and a separate visual indication of whether the tank 11 if full and energized. In one embodiment, the indicator lights define LED lights.

In one embodiment, this switching operation of the electrical contactor 21 is controlled by the operation of the liquid level switch 20. Specifically, the liquid level switch 20 is operative to detect the level of water in the water tank 11, specifically whether the water tank is full, and operate the switching of the electrical contactor 21 based on whether the level of water in the water tank 11 equals this threshold. It is contemplated that with the tank 11 full, the uppermost heating element 12 in the water tank 11 is guaranteed to be submerged. In this regard, the liquid level switch 20, which is mounted adjacent to the top of the water tank 11, is in its energizing position when its float is actuated to indicate the presence of the water level. On the other hand, the liquid level switch 20 is in its interrupting position when the float indicates a level of water beneath the top of the tank. In one embodiment, the liquid level switch 20 may define one of the L8 Series Flotect® Liquid Level Switches from Dwyer®. In alternate embodiments, an equivalent liquid level switch may be employed alternatively.

While in the energizing position, the liquid level switch 20 energizes the electrical contactor 21 to cause the electrical contactor 21 to make the circuit between the input voltage line 14 and the thermostats 13 and heating elements 12 and while in the interrupting position, the liquid level switch 20 causes the electrical contactor 21 to break the circuit between the input voltage line 14 and the thermostats 13 and heating elements 12.

In an alternate embodiment, an on/off float switch is employed with one two pole electrical contactor, with each electrical contactor associated with all of the thermostat and heating element pairs. In such an embodiment, the float switch has a lower threshold corresponding to the lowermost heating element and an upper threshold corresponding to the uppermost heating element and is operative to energize the electrical contactor corresponding to the lowermost heating element while the lower threshold is exceeded and/or energize the electrical contactors not until the upper threshold is exceeded.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A self regulating mechanism for a storage water heater, comprising:
an electrical contactor integral with a storage water heater and configured to selectively make and break a circuit which delivers electricity to at least one heating element integral with a water tank in the storage water heater, thereby controlling the flow of electricity to the at least one heating element; and
at least one switch integral with the storage water heater and configured to detect whether water in the water tank meets a predefined threshold and energize the electrical contactor if the water in the water tank meets the predefined threshold so as to cause the electrical contactor to make the circuit which delivers electricity to the at least one heating element.

2. The self regulating mechanism of claim 1, wherein said switch is additionally configured to cause the electrical contactor to break the circuit which delivers electricity to the at least one heating element.

3. The self regulating mechanism of claim 2, wherein the electrical contactor is configured to selectively make and break a circuit which delivers electricity to the at least one heating element through being wired between an input voltage line and the at least one heating element.

4. The self regulating mechanism of claim 2, wherein:
the at least one heating element includes an uppermost heating element and a lowermost heating element; and
the predefined threshold defines a water level that is at least above the uppermost heating element.

5. The self regulating mechanism of claim 4, wherein the electrical contactor is configured to selectively make and break a circuit which delivers electricity to the at least one heating element through being wired between an input voltage line and the at least one heating element.

6. The self regulating mechanism of claim 1, wherein the switch defines a liquid level switch.

7. A self regulating mechanism for a storage water heater, comprising:
an electrical contactor integral with a storage water heater having a top surface, wherein the electrical contactor is configured to selectively make and break a circuit which delivers electricity to at least one heating element integral with a water tank in the storage water heater, thereby controlling the flow of electricity to the at least one heating element;
at least one liquid level switch integral with the top surface of the storage water heater and configured to detect whether water in the water tank meets a predefined threshold and energize the electrical contactor if the water in the water tank meets the predefined threshold so as to cause the electrical contactor to make the circuit which delivers electricity to the at least one heating element; and
said liquid level switch additionally configured to cause the electrical contactor to break the circuit which delivers electricity to the at least one heating element.

8. The self regulating mechanism of claim 7, wherein the at least one heating element includes an uppermost heating element and a lowermost heating element and the predefined threshold defines a water level that is at least above the uppermost heating element.

9. The self regulating mechanism of claim 7, wherein the electrical contactor is configured to selectively make and break a circuit which delivers electricity to the at least one heating element through being wired between an input voltage line and the at least one heating element.
